(19) United States
(12) Patent Application Publication
(10) Pub. No.: US 2025/0355480 A1
(43) Pub. Date: Nov. 20, 2025

(54) LOW-POWER ISLAND FOR DISPLAY INTERFACE

(71) Applicant: QUALCOMM Incorporated, San Diego, CA (US)

(72) Inventors: Nan ZHANG, Beijing (CN); Yongjun XU, Beijing (CN)

(21) Appl. No.: 18/871,404

(22) PCT Filed: Jun. 16, 2022
(86) PCT No.: PCT/CN2022/099139

§ 371 Date: Dec. 3, 2024

(51) Int. Cl. G06F 1/3212

(52) U.S. Cl. CPC G06F 1/3212

(57) ABSTRACT

A mobile communication device includes a first physical layer circuit powered by a first power supply and configured to communicate first frames of data over a first serial bus to a display controller in a high-speed mode and to refrain from communicating over the first serial bus when the display controller is operated in a low-power mode, a second physical layer circuit powered by a second power supply and configured to communicate second frames of data at a second data rate over a second serial bus to the display controller in the low-power mode, a first processor powered by the first power supply and configured to generate the first frames of data, and a second processor powered by the second power supply and configured to provide the second frames of data to the second physical layer circuit when the display controller is operated in the low-power mode.

### TECHNICAL FIELD

The present disclosure relates generally to serial communication over a serial bus in a wireless communication device and, more particularly, to low-power modes of communication for a display subsystem interface.

### BACKGROUND

Mobile communication devices typically include a variety of components such as circuit boards, integrated circuit (IC) devices, application-specific integrated circuit (ASIC) devices and/or System-on-Chip (SoC) devices. The types of components may include processing circuits, user interface components, storage and other peripheral components that communicate over a serial bus. The serial bus may be operated in accordance with a standardized or proprietary protocol. In one example, the serial bus can be operated in accordance with an Inter-Integrated Circuit (I2C or I²C) communication protocol. The I2C bus is configured as a multi-drop bus and was developed to connect low-speed peripherals to a processor. The two wires of an I2C bus include a Serial Data Line (SDA) that carries a data signal, and a Serial Clock Line (SCL) that carries a clock signal.

In another example, the serial bus can be operated in accordance with a serial peripheral interface (SPI) communication protocol, in which a clock signal controls synchronous serial data exchanges between the master and slave devices. SPI protocols enable data to be communicated using two or more data lines of the serial bus and permits the serial bus to be configured for multidrop operation. Since one or more of the data lines may be shared by receiving devices, access to shared data lines is controlled using select signals provided to the devices coupled to the bus.

In another example, the serial bus can be operated in accordance with a multi-master protocol such that one or more devices may be a designated as a bus master or host device for the serial bus. A device may serve as a bus master in some transmissions and as a slave or subordinate device in other transmissions. In one example, Improved Inter-Integrated Circuit (13C) protocols may be used to control operations on a serial bus. I3C protocols are defined by the Mobile Industry Processor Interface (MIPI) Alliance and derive certain implementation aspects from the I2C protocol. In another example, the Radio Frequency Front-End (RFFE) interface defined by the MIPI Alliance provides a communication interface for controlling various radio frequency (RF) front-end devices, including power amplifiers (PAs), low-noise amplifiers (LNAs), antenna tuners, filters, sensors, power management devices, switches, etc. These devices may be collocated in a single IC device or provided in multiple IC devices. Multiple antennas and radio transceivers may be provided in a mobile communication device to support multiple concurrent RF links. In another example, the system power management interface (SPMI) defined by the MIPI Alliance provides a hardware interface that may be implemented between baseband or application processors and peripheral components. The SPMI may be used to support power management and for other operations within a device or system. Multiple standards are defined for interconnecting certain types of components in mobile communication devices. For example, there are multiple types of interfaces defined for communication between an application processor and display or camera components in a mobile communication device. Some components employ an interface that conforms to one or more standards or protocols specified by the MIPI Alliance, including standards and protocols for a camera serial interface (CSI) and a display serial interface (DSI).

The MIPI Alliance DSI, DSI-2 (referred to individually or collectively herein as DSI) and CSI and CSI-2 (referred to individually or collectively herein as CSI) standards define wired interfaces that can be deployed within an IC or between some combination of IC devices and SoC devices. CSI protocols may be used to couple a camera and application processor. DSI protocols may be used to couple an application processor and display subsystem. The low-level physical-layer (PHY) interface in each of these applications can be implemented in accordance with MIPI Alliance C-PHY or D-PHY standards and protocols. High-speed modes and low-power modes of communication are defined for C-PHY and D-PHY interfaces. The C-PHY high-speed mode uses a low-voltage multiphase signal transmitted in different phases on a 3-wire link. The D-PHY high-speed mode uses multiple 2-wire lanes to carry low-voltage differential signals. The low-power modes of C-PHY and D-PHY interfaces provide lower rates than the high-speed modes and transmit signals at higher voltages.

As device technology improves, a combination of demand for higher data rates over serial buses and the use of multiple mode display panels tends to increase power consumption. The display subsystem and related circuits exchange data at high data rates and consume a substantial portion of the power available in mobile communication devices and other portable devices. There is an ongoing need to improve power conservation in mobile communication devices and other portable devices.

### SUMMARY

Certain aspects of the disclosure relate to systems, apparatus, methods and techniques that enable mobile communication devices and other portable devices to idle data communication links between and within processors and display subsystems, and to enable larger portions of the mobile communication devices and other portable devices to enter sleep modes when the display is dormant.

In various aspects of the disclosure, a mobile communication device includes a display controller coupled to a display panel, a first physical layer circuit powered by a first power supply, a second physical layer circuit powered by a second power supply, a first processor powered by the first power supply and a second processor powered by the second power supply. The first physical layer circuit is configured to communicate first frames of data at a first data rate over a first serial bus to the display controller when the display controller is operated in a high-speed mode, and refrain from communicating over the first serial bus when the display controller is operated in a low-power mode. The second physical layer circuit is configured to communicate second frames of data at a second data rate over a second serial bus to the display controller when the display controller is operated in the low-power mode. The first processor is configured to generate the first frames of data, and the second processor is configured to provide the second frames of data to the second physical layer circuit when the display controller is operated in the low-power mode.

In various aspects of the disclosure, a method for operating a display in a mobile communication device includes configuring a first physical layer circuit powered by a first power supply to communicate first frames of data at a first data rate over a first serial bus to a display controller when the display controller is operated in a high-speed mode, and refrain from communicating over the first serial bus when the display controller is operated in a low-power mode. The method further includes configuring a second physical layer circuit powered by a second power supply to communicate second frames of data at a second data rate over a second serial bus to the display controller when the display controller is operated in the low-power mode. The method further includes configuring a first processor to generate the first frames of data, the first processor being powered by the first power supply, and configuring a second processor to provide the second frames of data to the second physical layer circuit when the display controller is operated in the low-power mode, the second processor being powered by the second power supply.

In various aspects of the disclosure, an apparatus includes means for communicating with a display controller and means for providing display data to the means for communicating with the display controller. The means for communicating with the display controller includes a first physical layer circuit powered by a first power supply and operable to communicate first frames of data at a first data rate over a first serial bus to the display controller when the display controller is operated in a high-speed mode, and refrain from communicating over the first serial bus when the display controller is operated in a low-power mode; and a second physical layer circuit powered by a second power supply and operable to communicate second frames of data at a second data rate over a second serial bus to the display controller when the display controller is operated in the low-power mod. The means for providing display data to the means for communicating with the display controller includes a first processor powered by the first power supply and configured to generate the first frames of data; and a second processor powered by the second power supply and configured to provide the second frames of data to the second physical layer circuit when the display controller is operated in the low-power mode. In various aspects of the disclosure, a processor-readable storage medium includes code for configuring a first physical layer circuit powered by a first power supply to communicate first frames of data at a first data rate over a first serial bus to a display controller when the display controller is operated in a high-speed mode, and refrain from communicating over the first serial bus when the display controller is operated in a low-power mode. The method further includes configuring a second physical layer circuit powered by a second power supply to communicate second frames of data at a second data rate over a second serial bus to the display controller when the display controller is operated in the low-power mode. The method further includes configuring a first processor to generate the first frames of data, the first processor being powered by the first power supply, and configuring a second processor to provide the second frames of data to the second physical layer circuit when the display controller is operated in the low-power mode, the second processor being powered by the second power supply.

In certain aspects, the first power supply provides power in the high-speed mode at a voltage that is greater than a voltage at which the second power supply provides power. The voltage at which the first power supply provides power may be reduced when the display controller is operated in the low-power mode. One or more devices or circuits powered by the first power supply may enter an idle, dormant, sleep or quiescent mode when the display controller is operated in the low-power mode. For example, the first processor may be configured to enter a dormant mode when the display controller is operated in the low-power mode. In another example, the first physical layer circuit may be configured to enter a dormant mode when the display controller is operated in the low-power mode. A low-power serial bus coupled to the first physical layer circuit may be idled when the physical layer circuit enters the dormant mode.

In certain aspects, the first physical layer circuit may be configured to operate in accordance with a MIPI Alliance DSI protocol. In one example, the DSI protocol may comply with or be compatible with C-PHY protocols. In another example, the DSI protocol may comply with or be compatible with D-PHY protocols.

In certain aspects, the second physical layer circuit may be configured to operate in accordance with a serial data communication protocol. In one example the physical layer circuit is configured to operate in accordance with SPI protocols. In another example the physical layer circuit is configured to operate in accordance with CCI protocols. In another example the physical layer circuit is configured to operate in accordance with I2C protocols. In another example the physical layer circuit is configured to operate in accordance with I3C protocols. In another example the physical layer circuit is configured to operate in accordance with SPMI protocols.

In certain aspects, the second processor is configured to communicate with a touch panel interface associated with the display panel over the second physical layer circuit. The second processor may be configured to configure manage and control the operation of the touch panel interface. The second processor may be configured to communicate with the touch panel interface when the display controller is operated in the high-speed mode. The second processor may be configured to communicate with the touch panel interface when the display controller is operated in the low-power mode.

### BRIEF DESCRIPTION OF THE DRAWINGS

FIG. 1 illustrates an apparatus employing a data link between IC devices and that is selectively operated according to a standard or proprietary protocol.

FIG. 2 illustrates examples of interface circuits that may be adapted in accordance with certain aspects of this disclosure.

FIG. 3 illustrates a system architecture for an apparatus employing a data link between IC devices.

FIG. 4 illustrates an example of a C-PHY interface that may be adapted according to certain aspects disclosed herein.

FIG. 5 illustrates an example of a D-PHY interface that may be adapted according to certain aspects disclosed herein.

FIG. 6 illustrates certain aspects of a 2-dataline serial peripheral interface that may be adapted according to certain aspects disclosed herein.

FIG. 7 illustrates certain aspects of a quad-serial peripheral interface that may be adapted according to certain aspects disclosed herein.

FIG. 8 illustrates a system that includes a display subsystem interface and that may be adapted in accordance with certain aspects of this disclosure.

FIG. 9 illustrates a system operated in a low-power mode in accordance with certain aspects of this disclosure.

FIG. 10 illustrates certain aspects of the high-speed mode operation of the system illustrated in FIG. 9.

FIG. 11 illustrates one example of an apparatus employing a processing circuit that may be adapted in accordance with certain aspects disclosed herein.

FIG. 12 is a flowchart that illustrates a method for operating a display in a mobile communication device in accordance with certain aspects disclosed herein.

FIG. 13 illustrates a first example of a hardware implementation for a communication apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Data communication links employed by SoCs and other IC devices to connect processors with modems and other peripherals may be operated in accordance with industry or proprietary standards or protocols associated with certain functions or types of devices. In the example of display panels, display subsystems, and display drivers, communication standards and protocols defined by the MIPI Alliance are frequently used. The Display Serial Interface (DSI®), for example, provides C-PHY and D-PHY standards and protocols used to define, configure and control a high-speed serial interface between a host processor and a display module. Control and management protocols may be used to operate other serial buses that couple the host processor and display module may include SPMI, I2C, 13C and/or protocols.

Mobile communication handsets typically support low-power modes of operation that can be initiated when the handset is idle. In conventional handsets that use DSI protocols to manage certain serial data links, there is little difference between high-speed and low-power modes of operation of the serial data links. Accordingly, it can be difficult or impossible to permit a processor in a host device that includes a serial data link or related circuits to enter a low-power mode when the handset is idle and DSI protocols are used to manage serial data link. According to certain aspects of this disclosure, data communication between a host device and a display driver can be transferred to a low-power serial data link when low-power mode is activated. The DSI physical layer circuits can be idled and the processor in the host device can enter a sleep mode.

### Examples Of Apparatus That Employ Serial Data Links

According to certain aspects of the disclosure, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

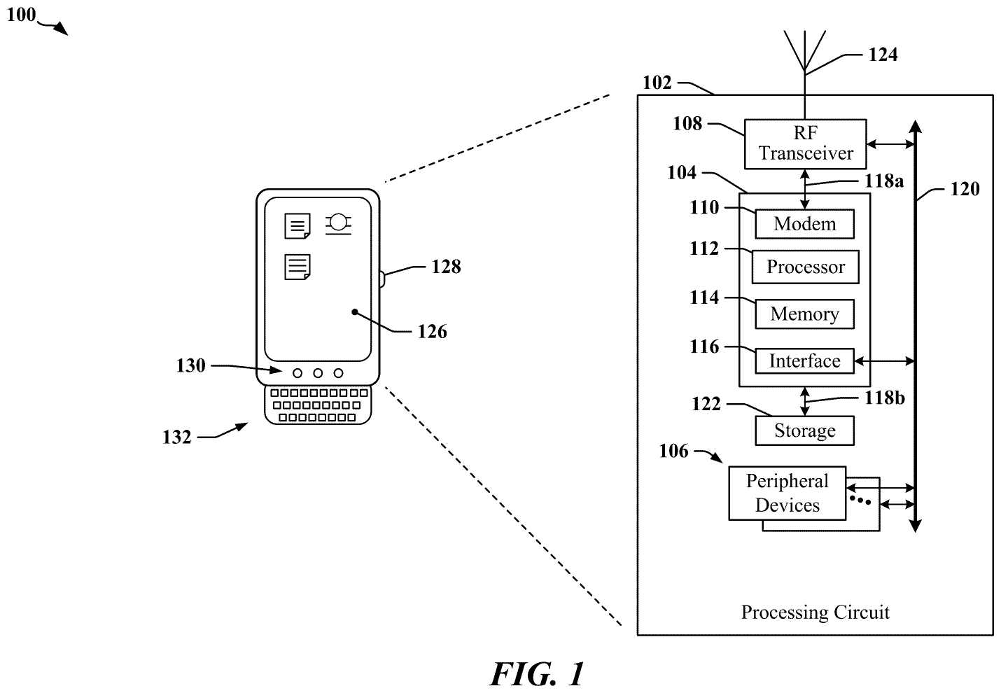

FIG. 1 illustrates an example of an apparatus 100 that employs a data communication bus. The apparatus 100 may include a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable communication between two or more devices 104, 106, and/or 108. In one example, the ASIC 104 may include one or more bus interface circuits 116 that includes a combination of circuits, counters, timers, control logic and other configurable circuits or modules. In one example, the bus interface circuits 116 may be configured to operate in accordance with standards-defined communication specifications or protocols. The processing circuit 102 may include or control a power management function that configures and manages the operation of the apparatus 100.

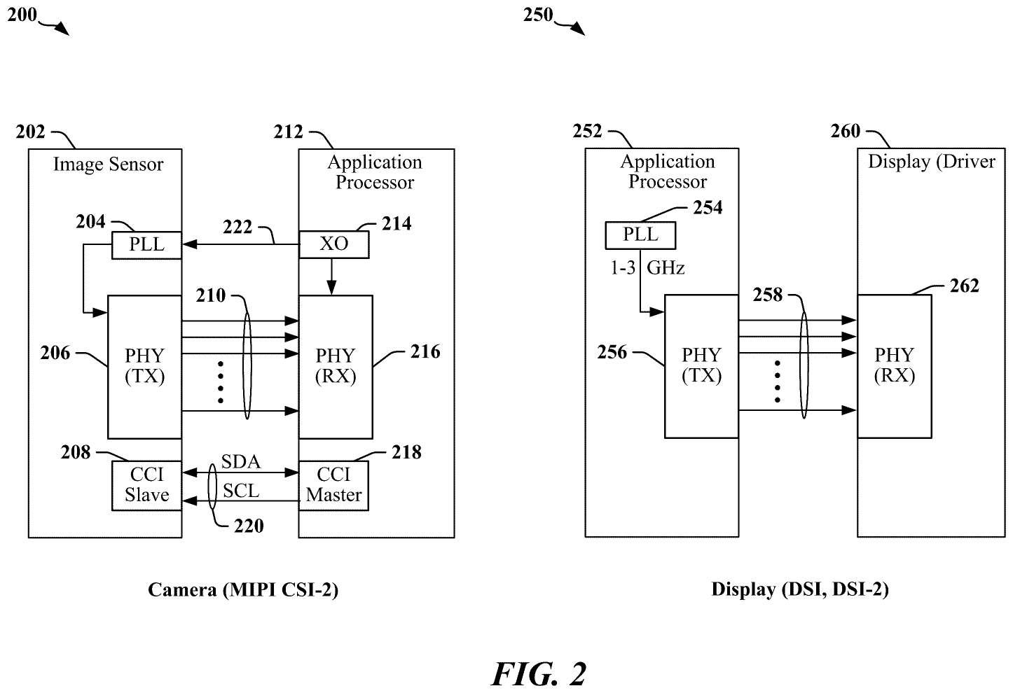

FIG. 2 illustrates examples of interface circuits that may be employed or adapted in accordance with certain aspects of this disclosure. A first interface circuit is configured as a camera subsystem 200 and a second interface circuit is configured as a display subsystem 250. The interface circuits may be deployed in a mobile communication device, for example. The camera subsystem 200 may include a CSI-2 defined communication link between an image sensor 202 and an application processor 212. The communication link may include a high-data rate data transfer link 210 used by the image sensor 202 to transmit image data to the application processor 212 using a transmitter 206. The high-data rate data transfer link 210 may be configured and operated according to D-PHY or C-PHY protocols. The application processor 212 may include a crystal oscillator (XO 214) or other clock source to generate a clock signal 222 that controls the operation of the transmitter 206. The clock signal 222 may be processed by a phase-locked loop (PLL) 204 in the image sensor 202. In some instances, the clock signal 222 may also be used by the D-PHY or C-PHY receiver 216 in the application processor 212. The communication link may include a Camera Control Interface (CCI), which is similar in nature to the Inter-Integrated Circuit (I2C) interface. The CCI bus may include a Serial Clock (SCL) line that carries a clock signal and a Serial Data (SDA) line that carries data. The CCI link 220 may be bidirectional and may operate at a lower data rate than the high-data rate data transfer link 210. The CCI link 220 may be used by the application processor 212 to exchange control and configuration information with the image sensor 202. The application processor 212 may include a CCI bus master 218 and the image sensor 202 may include a CCI slave 208.

The display subsystem 250 may include a unidirectional data link 258 that can be configured and operated according to D-PHY or C-PHY protocols. In the application processor 252, a clock source such as the PLL 254 may be used to generate a bit clock signal used by a D-PHY or C-PHY receiver 256 to control transmissions on the data link 258. At the display driver 260, a D-PHY or C-PHY receiver 262 may extract embedded clock information from sequences of symbols transmitted on the data link, or from a clock lane provided in the data link 258.

Certain aspects disclosed herein relate to systems, apparatus and methods that support a broad range of interface protocols, and that can operate using different physical media. As shown in FIG. 2, for example, the camera subsystem 200 and/or display subsystem 250 may communicate high data rate information using D-PHY or C-PHY protocols. In some configurations, the camera subsystem 200 and/or display subsystem 250 may communicate using a reverse channel (e.g., the CCI link 220) for configuration of an image sensor 202 or other device. In some instances, a low-power mode of operation may be defined for links that use either D-PHY or C-PHY protocols.

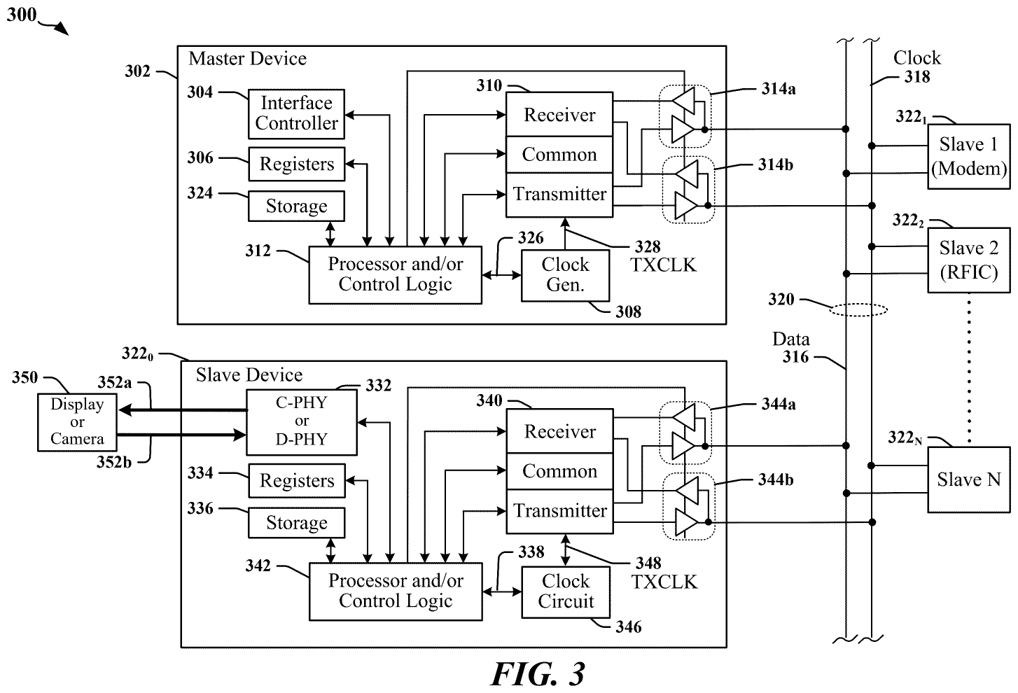

FIG. 3 illustrates an example of an apparatus 300 employing a data link that may be used to communicatively couple two or more devices, subcomponents or circuits. Here, the apparatus 300 includes multiple devices 302, and 322₀-322_{N} coupled to a two-wire serial bus 320. The devices 302 and 322₀-322_{N} may be implemented in one or more semiconductor IC devices, such as an application processor, SoC or ASIC. In various implementations certain of the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more devices 322₀-322_{N} may be used to control, manage or monitor a sensor device. Communication between devices 302 and 322₀-322_{N} over the serial bus 320 is controlled by a bus master device 302. Certain types of bus can support multiple bus masters 302.

In one example, a bus master device 302 may include an interface controller 304 that may manage access to the serial bus, configure dynamic addresses for slave devices and/or generate a clock signal 328 to be transmitted on a clock line 318 of the serial bus 320. The bus master device 302 may include configuration registers 306 or other storage 324, and other control logic 312 configured to handle protocols and/or higher-level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clocks 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a device 322₀ configured to operate as a slave device may provide a control function, physical layer circuit 332 that includes circuits and modules to support a display, an image sensor, and/or circuits and modules that control and communicate with one or more sensors that measure environmental conditions. In this example, the device 322₀ can include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 340 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. In some instances, the clock signal 348 may be derived from a signal received from the clock line 318. Other timing clocks 338 may be used by the control logic 342 and other functions, circuits or modules.

The serial bus 320 may be operated in accordance with RFFE, I2C, I3C, SPI, SPMI or another suitable protocol. In some instances, two or more devices 302, 322₀-322_{N} may be configured to operate as a bus master device on the serial bus 320. In some instances, the apparatus 300 includes multiple serial buses 320, 352a and/or 352b that couple two or more of the devices 302, 322₀-322_{N} or one of the devices 302, 322₀-322_{N} and a peripheral device such as a display or camera 350 or a Radio-Frequency IC (RFIC). In some examples, one slave device 322₀ is configured to operate as a display or camera coupled to a display or camera 350. The latter slave device 322₀ may include a physical layer circuit 332 that is configured to operate as a C-PHY or D-PHY interface controller that communicates with the display or camera 350 over a serial bus 352a or 352b operated in accordance with a C-PHY protocol or a D-PHY protocol.

In certain aspects of this disclosure, systems and apparatus may employ multi-phase data encoding and decoding interface methods for communicating between IC devices. A multi-phase encoder may drive a plurality of conductors (i.e., 3 conductors). Each conductor may be referred to as a wire, although the conductors may include conductive traces on a circuit board or traces or interconnects within a conductive layer of a semiconductor IC device. In one example, a physical layer interface implemented using MIPI Alliance-defined C-PHY technology and protocols (i.e., a C-PHY interface) may be used to connect camera or display to an application processor. The C-PHY interface employs three-phase symbol encoding to transmit data symbols on 3-wire lanes, or “trios” where each trio includes an embedded clock. A trio may be referred to as a lane herein. A multi-lane C-PHY communication channel may be established using multiple trios to carry data exchanged between a pair of devices, where each channel includes one trio that carries a portion of the data, which may be independently encoded in accordance with C-PHY protocols.

The C-PHY interface provides a three-phase encoding scheme for a three-wire system may define three phase states and two polarities, providing 6 states and 5 possible transitions from each state. Deterministic voltage and/or current changes may be detected and decoded to extract data from the three wires.

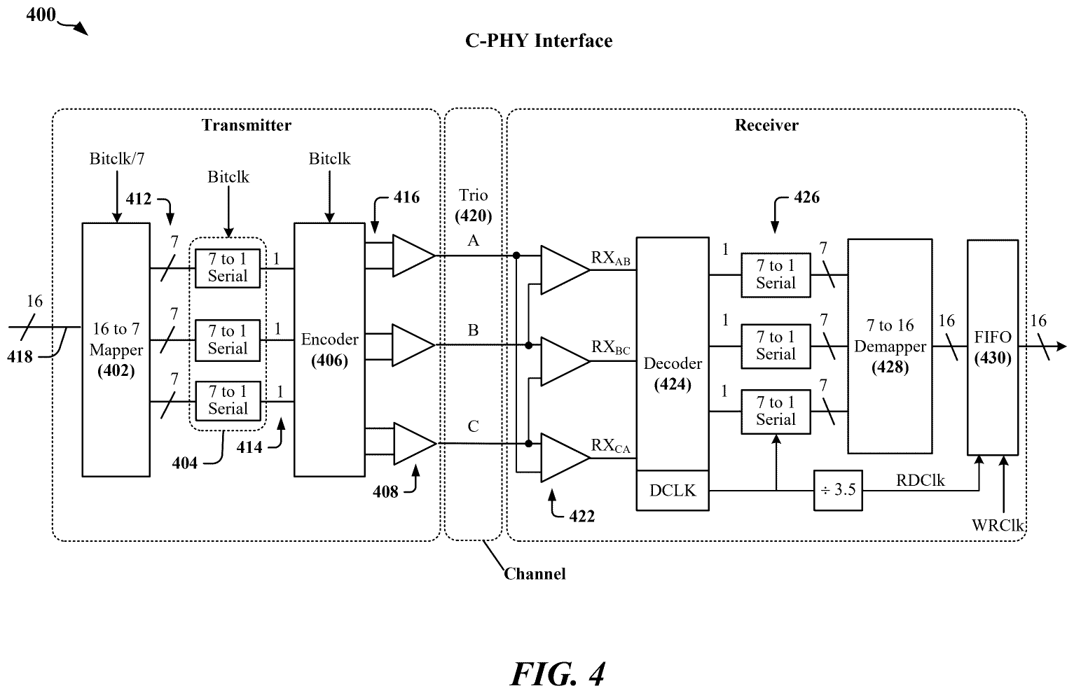

FIG. 4 illustrates a C-PHY interface 400 that may be used to implement certain aspects of the serial bus 352a or 352b depicted in FIG. 3. The illustrated example may relate to a three-wire link configured to carry three-phase polarity encoded data in accordance with DSI protocols. The use of 3-phase polarity encoding provides for high-speed data transfer and may consume half or less of the power of other interfaces at the desired operating frequency because fewer than 3 drivers are active at any time in a C-PHY link. The C-PHY interface uses 3-phase polarity encoding to encode multiple bits per symbol transition on the three-wire link. In one example, a combination of three-phase encoding and polarity encoding may be used to support a wide video graphics array (WVGA), 80 frames per second liquid crystal display driver IC without a frame buffer, delivering pixel data for display refresh at 810 Mbps over three or more wires.

In the depicted C-PHY interface 400, three-phase polarity encoding is used to control signaling state of connectors, wires, traces and other interconnects that provide a channel for communication. In the illustrated example, a single unidirectional channel, or lane, is provided using a combination of three wires (the trio 420). Each wire in the trio 420 may be undriven, driven positive, or driven negative in any symbol transmission interval. In some instances, an undriven signal wire of the trio 420 may be in a high-impedance state. In some instances, an undriven signal wire of the trio 420 may be driven or pulled to a voltage level that lies substantially halfway between the positive and negative voltage levels provided on driven signal wires. In some instances, an undriven signal wire of the trio 420 may have no current flowing through it. Drivers 408 coupled to the signal wires of the trio 420 are controlled such that only one wire of the trio 420 is in each of three states (denoted as +1, −1, or 0) in each symbol interval.

In one example, drivers 408 may include unit-level current-mode drivers. In another example, drivers 408 may drive opposite polarity voltages on two signals transmitted on two signal wires of the trio 420 while the third signal wire is at high impedance and/or pulled to ground. For each transmitted symbol interval, at least one signal is in the undriven (0) state, while one signal is driven to the positive (+1 state) and one signal is driven to the negative (−1 state), such that the sum of current flowing to the receiver is always zero. For each symbol, the state of at least one signal wire of the trio 420 is changed from the symbol transmitted in the preceding transmission interval.

In the C-PHY interface 400, a mapper 402 may receive a 16-bit input data word 418, and the mapper 402 may map the input data word 418 to 7 symbols 412 for transmitting sequentially over the signal wires of the trio 420. An M-wire, N-phase encoder 406 configured for three-wire, three-phase encoding receives the 7 symbols 412 produced by the mapper one input symbol 414 at a time and computes the state of each signal wire of the trio 420 for each symbol interval, based on the immediately preceding state of the signal wires of the trio 420. The 7 symbols 412 may be serialized using parallel-to-serial converters 404, for example. The encoder 406 provides control signals 416 to define the outputs of the drivers 408. The encoder 406 selects the states of the signal wires of the trio 420 based on the input symbol 414 and the previous states of signal wires of the trio 420 and may provide control signals 416 to cause the drivers 408 to produce the desired signaling state on the trio 420.

The use of three-wire, three-phase encoding permits several bits to be encoded in a plurality of symbols where the bits per symbol is not an integer. In the example of a three-wire, three-phase system, there are 3 available combinations of 2 wires, which may be driven simultaneously, and 2 possible combinations of polarity on the simultaneously driven pair of wires, yielding 6 possible states. Since each transition occurs from a current state, 5 of the 6 states are available at every transition. With 5 states, log₂(5)≈2.32 bits may be encoded per symbol transition. Accordingly, a mapper may accept a 16-bit word and convert it to 7 symbols because 7 symbols carrying 2.32 bits per symbol can encode 16.24 bits. In other words, a combination of seven symbols that encodes five states has 57 (78,125) permutations. Accordingly, the 7 symbols may be used to encode the 2¹⁶ (65,536) permutations of 16 bits.

The C-PHY interface 400 includes a receiver that includes comparators 422 and a decoder 424 that are configured to provide a digital representation of the state of each of three signal wires of the trio 420, as well as the change in the state of the three signal wires compared to the state transmitted in the previous symbol period. Seven consecutive states are assembled by serial-to-parallel convertors 426 and used to produce a set of 7 symbols to be processed by a demapper 428 to obtain 16 bits of data that may be buffered in a first-in-first-out (FIFO) storage device 430, which may be implemented using registers, for example.

According to certain aspects disclosed herein, systems and apparatus may employ some combination of differential and single-ended encoding for communicating between IC devices. In one example, the MIPI Alliance-defined “D-PHY” physical layer interface technology may be used to connect camera and display devices to an application processor. The D-PHY interface can switch between a differential (High-Speed) mode and a single-ended low-power (LP) mode in real time as needed to facilitate the transfer of large amounts of data or to conserve power and prolong battery life. The D-PHY interface is capable of operating in simplex or duplex configuration with single data lane or multiple data lanes with a unidirectional (Master to Slave) clock lane. In one example, a data lane is implemented using a single wire. Single-wire lanes may be used at lower data rates that are used to generate data signals that can be transmitted with limited losses such that a receiver can readily decode the data carried over the data lane. Two-wire lanes that carry differentially encoded clock and data signals provide common mode rejection of electromagnetic interference and can limit attenuation of higher frequency components in signals transmitted over the lanes.

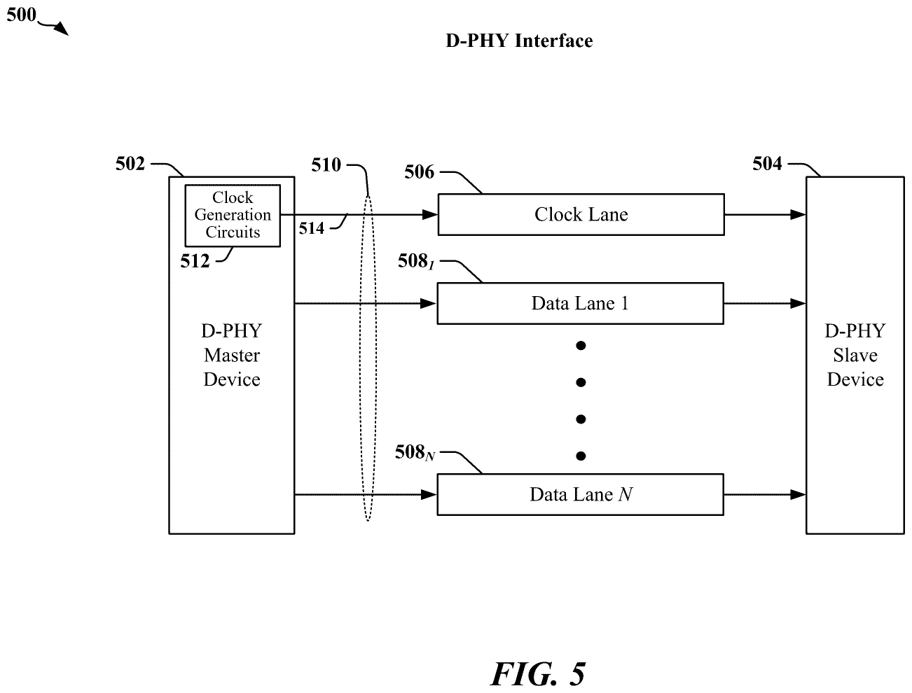

FIG. 5 illustrates a generalized example of a D-PHY interface 500 that includes a bus master device 502 and a slave device 504 coupled using a set of wires 510 that are used to provide a clock lane 506 and one or more data lanes 5081-508N. For high-speed operation, the clock lane 506 and the data lanes 5081-508N may each be provided using a pair of wires to carry a differential signal. In one example, the slave device 504 is provided in a display driver IC (DDIC) associated with a display panel, and the bus master device 502 is included in an application processor or provided by another processing circuit.

In the illustrated example, a clock signal is transmitted on a clock lane 506 and data is transmitted in one or more data lanes 5081-508N. The bus master device 502 includes clock generation circuits 512 that can be configured to generate a clock signal 514 that is transmitted over the clock lane 506 to control transmissions over the data lanes 5081-508N. The frequency of the clock signal 514 may be configured during system initialization or configuration and/or may be dynamically configured based on mode of operation of the D-PHY interface 500, application needs, volumes of data to be transferred and power conservation needs. The number of data lanes 5081-508N that are provided or that are active in a device may be configured during system initialization or configuration and/or may be dynamically configured based on mode of operation of the D-PHY interface 500, application needs, volumes of data to be transferred and power conservation needs.

### Examples of Serial Peripheral Interfaces

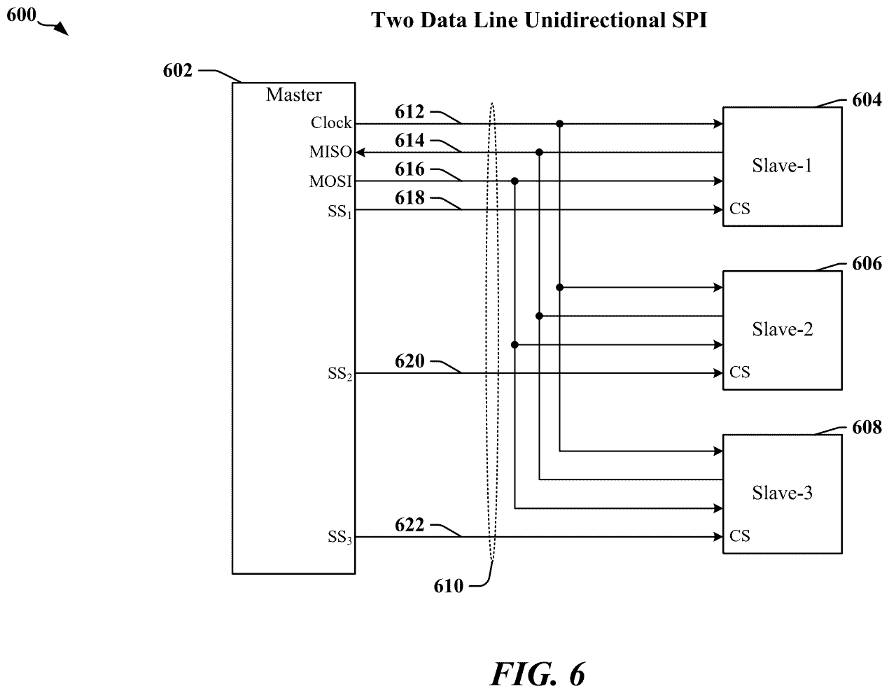

In accordance with certain aspects of this disclosure, a serial bus operated in accordance with SPI protocols can be used to provide a simple, low-power communication interface. In one example, the SPI interface may be used primarily to exchange data between a processing circuit and a touch panel of a display. An SPI interface may be coupled to a serial bus that has a clock wire, two data lines (Master In Slave Out (MISO) line, Master Out Slave In (MOSI) line) and a Chip Select (CS) for each slave device. The presence of MISO and MOSI lines enables full-duplex operation. FIG. 6 illustrates certain aspects related to the operation a two data line SPI 600. In some instances, a master device 602 may be incorporated in an SoC that serves as an application processor, host processor, or other functional component of an apparatus or system. The master device 602 is coupled to multiple slave devices 604, 606, 608 using a multi-wire bus 610. The master device 602 drives data to the slave devices 604, 606, 608 over a master-out-slave-in line (MOSI line 616) of the multi-wire bus 610. The slave devices 604, 606, 608 may each drive data to the master device 602 over a shared master-in-slave-out line (MISO line 614) of the multi-wire bus 610.

The multi-wire bus 610 includes at least one slave select line 618, 620, 622 for each slave device 604, 606, 608. As illustrated, a first slave select line 618 (SS1) controls bus access by the first slave device 604, a second slave select line 620 (SS2) controls bus access by the second slave device 606, and a third slave select line 622 (SS3) controls bus access by the third slave device 604. The master device 602 may assert a slave select line 618, 620, 622 to cause a corresponding slave device 604, 606, 608 to receive data over the MOSI line 616, and/or to grant permission to the corresponding slave device 604, 606, 608 to transmit on the MISO line 614.

In one example, the slave select lines 618, 620, 622 are not asserted when a low voltage level is applied to the slave select lines 618, 620, 622, and a slave select line 618, 620, 622 is asserted by driving the slave select line 618, 620, 622 to a high voltage level (e.g., towards the power supply level). In another example, the slave select lines 618, 620, 622 are not asserted when a high voltage level (e.g., the power supply level) is applied to the slave select lines 618, 620, 622, and a slave select line 618, 620, 622 is asserted by driving the slave select line 618, 620, 622 to a low voltage level. For each slave select line 618, 620, 622, a driver in the master device 602 may be operated to charge and discharge the slave select line 618, 620, 622 based on assertion state desired for the slave select line 618, 620, 622.

Data is transmitted between the master device 602 and a slave device 604, 606, 608 in accordance with a clock signal provided on a clock line 612 of the multi-wire bus 610. Data signaling is unidirectional on the MISO line 614 and on the MOSI line 616. Data is transferred over the MISO line 614 in a direction opposite to that of data transferred over the MOSI line 616. Data transfers over the MISO line 614 and MOSI line 616 are synchronized to the clock signal provided on the clock line 612.

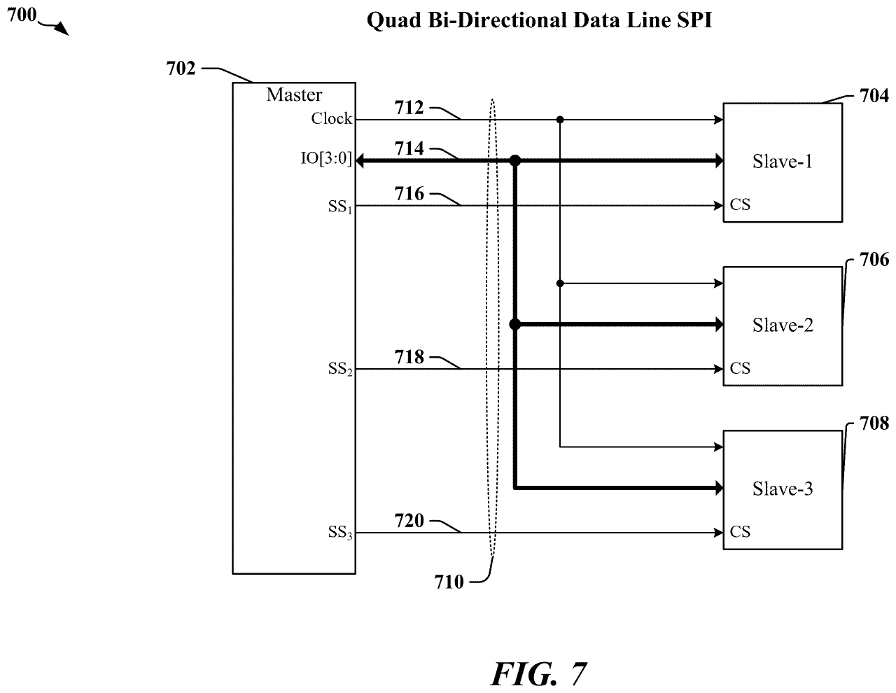

FIG. 7 illustrates certain aspects of a quad serial peripheral interface (QSPI) 700. A master device 702 may be incorporated in an SoC that serves as an application processor, host processor, or other functional component of an apparatus or system. The master device 702 is coupled to multiple slave devices 704, 706, 708 through a multi-wire bus 710. The master device 702 exchanges data with the slave devices 704, 706, 708 over a data channel 714 of the multi-wire bus 710, where the data channel 714 includes two data lines in each direction (master-slave and slave-master). The data channel 714 may be employed to provide greater data transfer rates than the two-wire unidirectional signaling scheme illustrated in FIG. 6.

The multi-wire bus 710 includes at least one slave select line for each slave device 704, 706, 708. As illustrated, a first slave select line 716 (SS1) controls bus access by the first slave device 704, a second slave select line 718 (SS2) controls bus access by the second slave device 706, and a third slave select line 720 (SS3) controls bus access by the third slave device 704. The master device 702 may assert a slave select line 716, 718, 720 to permit and/or cause a corresponding slave device 704, 706, 708 to transmit or receive data over the data channel 714.

In one example, the slave select lines 716, 718, 720 are not asserted when a low voltage level is applied to the slave select lines 716, 718, 720, and a slave select line 716, 718, 720 is asserted by driving the slave select line 716, 718, 720 to a high voltage level (e.g., towards the power supply level). In another example, the slave select lines 716, 718, 720 are not asserted when a high voltage level (e.g., the power supply level) is applied to the slave select lines 716, 718, 720, and a slave select line 716, 718, 720 is asserted by driving the slave select line 716, 718, 720 to a low voltage level. For each slave select line 716, 718, 720, a driver in the master device 702 may be operated to charge and discharge the slave select line 716, 718, 720 based on assertion state desired for the slave select line 716, 718, 720.

Data is transmitted between the master device 702 and a slave device 704, 706, 708 in accordance with a clock signal provided on a clock line 712 of the multi-wire bus 710. Data transfers on the data channel 714 are synchronized to the clock signal provided on the clock line 712.

In many portable or mobile devices, the display subsystem consumes a significant portion of the power budget defined for the devices. For example, the power budget for a cellular telephone may be defined with the goal of maximizing available operating time between battery charging events, as well as minimizing heat generation and heat mitigation issues. The power budget may be defined based on tradeoffs between power demands associated with wireless communication schedules and a requirement to maintain a responsive user interface. Certain elements of the display subsystem in a portable or mobile device operate in a high-speed mode including when the display is blanked or idle. In one example, the DSI circuits consume similar power levels when the portable or mobile device is operated in an active mode (e.g., “Display Always On”) or a quiescent mode such as “Sleep”, “Dormant”, “Display Idle” or “Smart Watch Display” modes. When the DSI circuits are continuously operated in high-speed mode, it is typically necessary to operate other circuits in the SoC or IC in high-speed mode, thereby increasing power consumption when the portable or mobile device is operated in quiescent modes.

Certain aspects of this disclosure can reduce power consumption attributable to display subsystems when the display is in a quiescent, dormant or idle mode. In one aspect, a high-speed data link operated in accordance with DSI protocols in high-speed, active modes can be operated by replacing the high-speed data link with a low-power data link in quiescent, dormant or idle modes. The physical interface and other circuits associated with the low-power data link can be located in a low-power domain or low-power island of an SoC or IC, allowing other circuits in the SoC or IC to be idled or placed into a sleep mode. In one example, the SoC or IC provides high-speed power domains and low-power domains/islands, where high-speed power domains can be operated at reduced power levels during quiescent, dormant or idle periods.

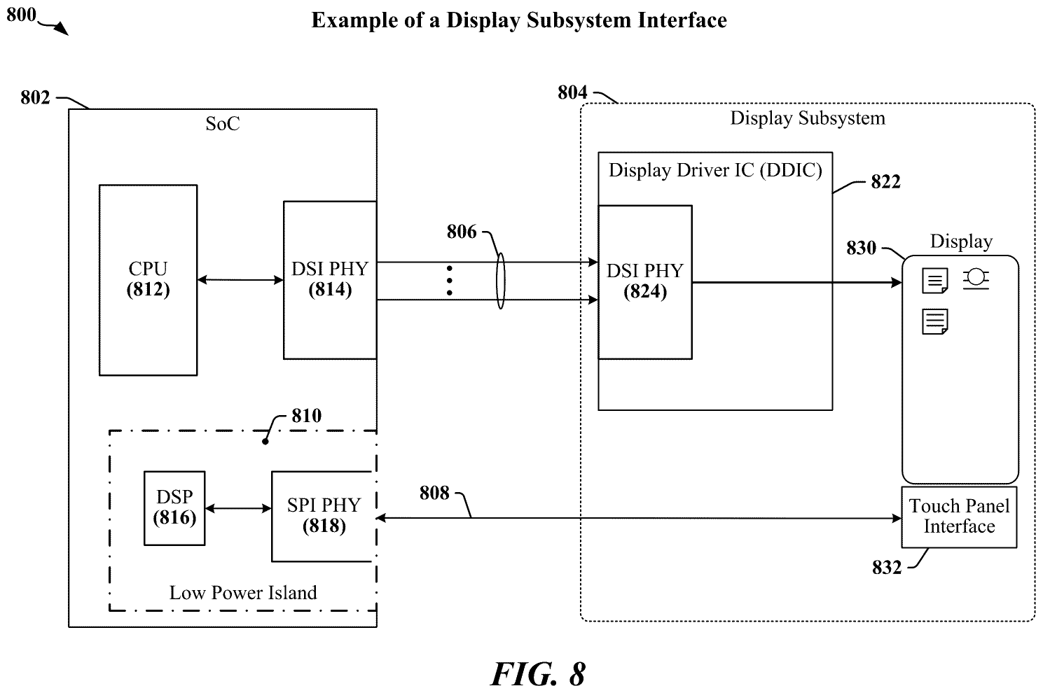

FIG. 8 illustrates a system 800 that includes a display subsystem interface and that may be adapted in accordance with certain aspects of this disclosure. The illustrated system 800 includes an SoC 802 and a display subsystem 804 that are communicatively coupled using a high-speed serial bus 806 and a low-power serial bus 808. The SoC 802 includes multiple processors including a central processing unit (the CPU 812) and a digital signal processor (the DSP 816). For the purposes of this disclosure, examples of high-speed serial data links are often described as being controlled and managed using DSI protocols, while examples of low-speed serial data links are often described as being controlled and managed using SPI protocols. In other examples, other types of communication protocols can be used to control or manage high-speed serial data links and low-speed serial data links. In the illustrated example, the SoC 802 includes a DSI physical interface (the DSI PHY 814) and an SPI physical interface (the SPI PHY 818).

In one aspect of the disclosure, at least two power domains are defined for the SoC 802, including a high-speed power domain and a low-power domain, where the low-power domain may be implemented or referred to herein as a low-power island 810. The high-speed power domains may support, supply and/or be included in a section of an IC or SoC that performs a variety of functions including storing data (memory), managing stored data, performing certain logic functions, processing-specific functions, cryptography, image processing, wireless and wired communication, and so on. More than one section of an IC may operate as a high-speed power domain. In the illustrated example, the CPU 812 and the DSI PHY 814 operate within a high-speed power domain.

In many examples, the devices and/or circuits in a high-speed power domain may be configurable to support operation at the highest possible operating frequency enabled by the process technology. In some examples, the operating frequency of circuits in a high-speed power domain may be constrained by a power budget and the operating frequency of some circuits may be configured to operate at the highest frequency that can be supported under the power budget. Lower power consumption in high-speed circuits can be achieved by reducing the operating voltage of the high-speed power domain.

In certain examples, the low-power island 810 may support, supply and/or be included in a section of the IC or SoC that performs real-time, low-frequency, and/or low data rate communication and that includes processing circuits associated with performance of real-time, low-frequency, and/or low data rate communication. In one example, the low-power island 810 may supply power to circuits and devices used for communication and processing functions associated with certain types of sensors. In another example, the low-power island may supply power to circuits and devices used for low data rate communication and processing.

In certain conventional systems, a dedicated display processing unit (DPU) used to configure, control and manage the display subsystem 804 is deployed within the high-speed power domain. In some instances, support circuits for an “always-on” camera may operate at least in part within the low-power island 810. A communication link for camera may be provided using circuits in a high-speed power domain since the camera typically transmits image date when a user is actively interacting with the portable or mobile device and the system 800 has entered a high-speed mode of operation. In the latter example, the camera, DSI PHY used to communicate with the camera and associated circuits can be idled when the portable or mobile device is dormant.

The display subsystem 804 includes display driver circuits, which may be implemented in a display driver IC (the DDIC 822) to drive a display panel 830. The display subsystem 804 may include a touch panel interface 832 associated with the display panel 830. In some instances, the touch panel interface 832 is included in the DDIC 822.

The DDIC 822 includes a DSI physical interface (the DSI PHY 824) configured as a receiving interface that is coupled to the high-speed serial bus 806. The illustrated DDIC 822 also includes a low-power serial bus 808. The touch panel interface 832 includes an SPI physical interface (not shown) that is coupled to the low-power serial bus 808, which may support bidirectional, full-duplex operation (see FIGS. 6 and 7). The touch panel interface 832 may be communicatively coupled to the DSP 816 through the low-power serial bus 808. The DSP 816 may be configured to support a user interface. For example, the DSP 816 may be configured to detect user contact with the display panel 830, multi-point contact and movement that can be decoded as user gestures. The DSP 816 may be configured to wake the system 800 from idle or sleep modes when active or new user contact or movement is detected.

In conventional mobile or portable devices, display subsystems maintain an active high-speed data communication link between the SoC 802 and the display subsystem 804 when the display subsystem 804 is in an idle or other quiescent mode. The circuits that implement and support the active high-speed data communication link are not suited for inclusion in the low-power island 810. The operation of the DSI PHY 824 in low-power display modes remains substantially unchanged from its operation in high-speed mode.

The continued operation of the DSI PHY 824 prevents the CPU 812 and/or the DPU from entering deep sleep mode. The level of power consumption attributable to the DSI PHY 824, DPU or CPU 812 and associated circuits during quiescent modes can render their inclusion in the low-power island 810 impracticable due to cost and complexity. Certain aspects of this disclosure relate to a display subsystem that can be operated in a low-power mode with substantial reductions in power consumption over conventional display subsystems. Power savings can be obtained by disabling the DSI PHY during low-power modes. The high-speed CPU or DPU is relieved of the responsibility for servicing the DSI PHY and can enter a deep sleep mode. The display subsystem is managed through a secondary, low-power communication link and can be serviced by a low-power processor. The low-power communication link and low-power processor may reside in a low-power island.

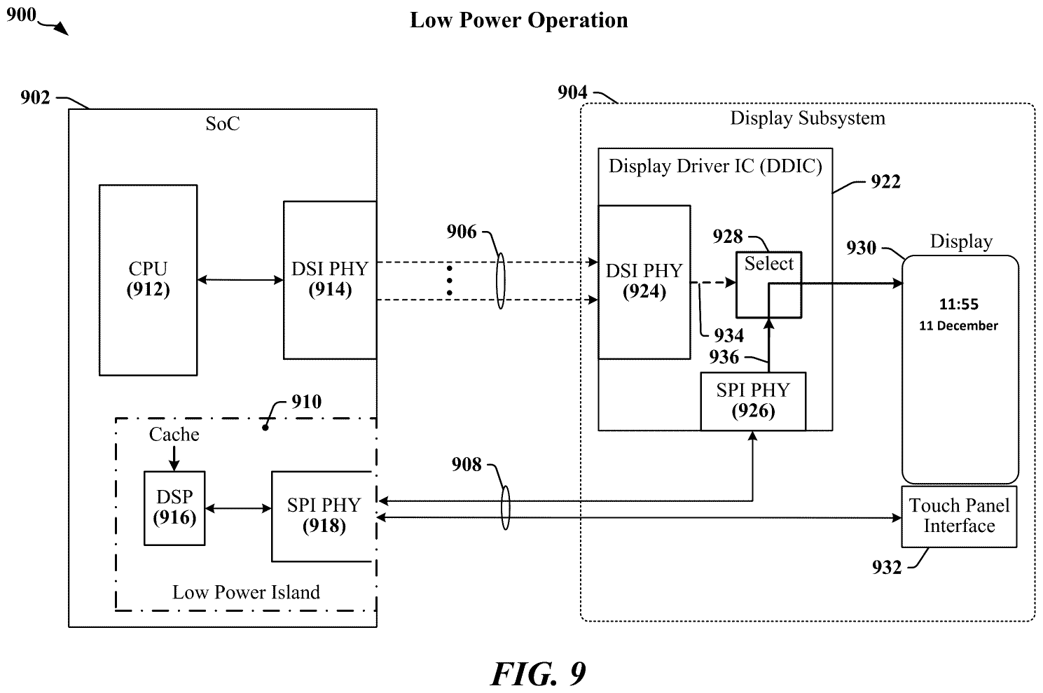

FIG. 9 illustrates a system 900 operated in a low-power mode in accordance with certain aspects of this disclosure. The system 900 corresponds in some respects to the system 800 illustrated in FIG. 8. For example, the system 900 includes an SoC 902 and a display subsystem 904 that are communicatively coupled using a high-speed serial bus 906 and a low-power serial bus 908. 808. The SoC 802 includes multiple processors including a central processing unit (the CPU 912) and a digital signal processor (the DSP 916). For the purposes of this disclosure, examples of high-speed serial data links are often described as being controlled and managed using DSI protocols, while examples of low-speed serial data links are often described as being controlled and managed using SPI protocols. In other examples, other types of communication protocols can be used to control or manage high-speed serial data links and low-speed serial data links. In the illustrated example, the SoC 902 includes a DSI physical layer interface (the DSI PHY 914) and an SPI physical layer interface (the SPI PHY 918).

In one aspect of the disclosure, at least two power domains are defined for the SoC 902, including a high-speed power domain and a low-power domain, where the low-power domain may be referred to herein as the low-power island 910. The high-speed power domain may support, supply and/or be included in a section of an IC or SoC that performs a variety of functions including storing data (memory), managing stored data, performing certain logic functions, processing-specific functions, cryptography, image processing, wireless and wired communication, and so on. More than one section of an IC may operate as a high-speed power domain. In the illustrated example, the CPU 912 and the DSI PHY 914 operate within a high-speed power domain.

In certain examples, the low-power island 910 may support, supply and/or be included in a section of the IC or SoC that performs real-time, low-frequency, and/or low data rate communication and that includes associated processing circuits. In one example, the low-power island 910 may supply power to circuits and devices used for communication and processing functions associated with certain types of sensors. In another example, the low-power island may supply power to circuits and devices used for low data rate communication and processing. In some systems, a dedicated display processing unit (DPU) is used to configure, control and manage the display subsystem 904 and the DPU in these systems is deployed within the high-speed power domain.

The display subsystem 904 includes display driver circuits, which may be implemented in a display driver IC (the DDIC 922) to drive a display panel 930. The display subsystem 904 may include a touch panel interface 932 associated with the display panel 930. In some implementation, the touch panel interface 932 is included in the DDIC 922.

The DDIC 922 includes a DSI physical interface (the DSI PHY 924), an SPI physical interface (the SPI PHY 926), and selection circuits represented by the selector 928. The DSI PHY 924 is configured as a receiving interface and is coupled to the high-speed serial bus 906. In the illustrated example, the SPI PHY 926 is coupled to the low-power serial bus 908, which is configured to support multiple devices and may be configured for bidirectional communication (see FIGS. 6 and 7).

The touch panel interface 932 includes an SPI physical layer interface (not shown) that is coupled to the low-power serial bus 908. In other examples, the DDIC 922 and the touch panel interface 932 can share a common SPI physical layer interface. The touch panel interface 932 is communicatively coupled to the DSP 916 through the low-power serial bus 908. The DSP 916 may be configured to support a user interface. For example, the DSP 916 may be configured to detect user contact with the display panel 930, multi-point contact and movement that can be decoded as user gestures. The DSP 916 may be configured to wake the system 900 from idle or sleep modes when active or new user contact or movement is detected.

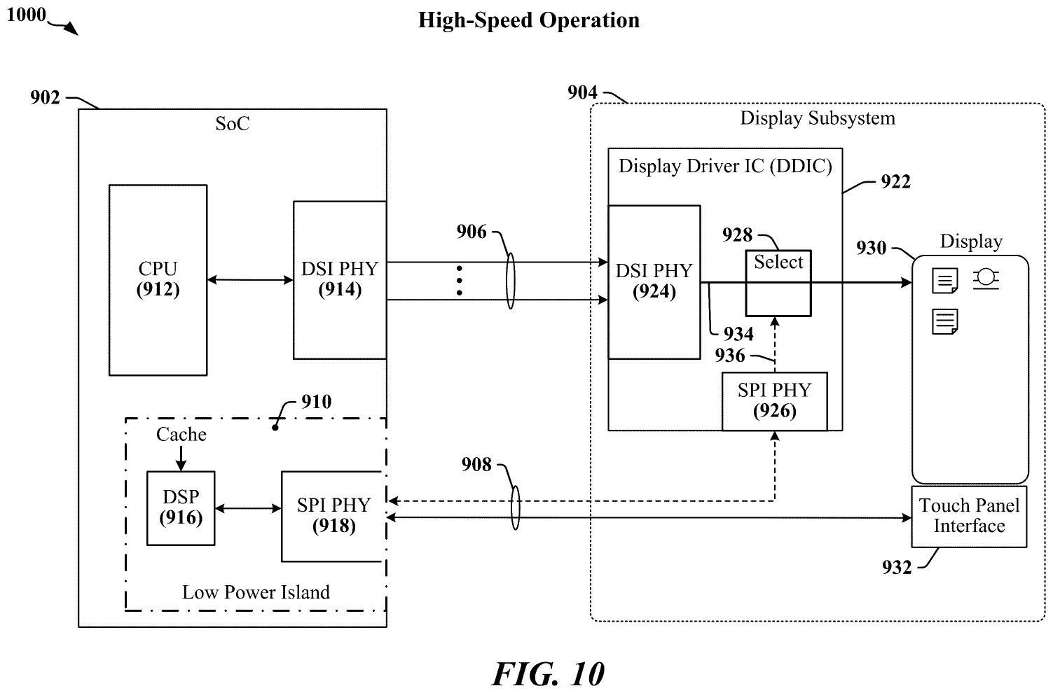

In the illustrated example, the DDIC 922 includes a selector 928 that is configured to select between the output 934 of the DSI PHY 924 and the output 936 of the SPI PHY 926 to supply the display data used to drive the display panel 930. In high-speed mode, the selector 928 selects the DSI PHY 924 to supply display data. In low-speed mode, the selector 928 selects the SPI PHY 926 to supply display data. FIG. 10 illustrates a configuration 1000 in which the system 900 is configured for a high-speed mode of operation in accordance with certain aspects of this disclosure.

The selector 928 may be implemented using switches, a multiplexer, or some combination of logic gates or drivers. In some implementations, the selector 928 represents a virtual switch where, for example, the DDIC 922 selects between different buffers or memory regions based on the mode of operation of the system 900. In the latter example, display data received through the DSI PHY 924 is written to first storage and display data received through the SPI PHY 926 and addressed to the display panel 930 is written to second storage. The DDIC 922 drives the display panel 930 using data stored in the first storage when operated in high-speed mode, and the DDIC 922 drives the display panel 930 using data stored in the second storage when the display subsystem 904 is operated in low-speed mode. In some instances, the DDIC 922 drives the display panel 930 using data stored in a common storage that is written by the currently active PHY 924 or 926. According to one aspect of this disclosure, the DSI PHY 914 in the SoC 902 and the DSI PHY 924 in the DDIC 922 can be disabled or placed in a low-power, sleep or quiescent mode when the display subsystem 904 is operated in low-speed mode. When the DSI PHY 914 in the SoC 902 is not operating, the CPU 912 may also be disabled or placed in a low-power, sleep or quiescent mode.

In low-speed modes, management and control of the display panel 930 may be exercised using components resident in the low-power island 910 and the low-power serial bus 908. In one example, the DSP 916 may transfer display data and commands to the DDIC 922 through the low-power serial bus 908. Display data may be provided in any suitable format and display data may define pixel settings within a display frame. In one example, the display data is stored in frame buffers. The display data may be retrieved from a cache that is resident in the low-power island 910 or otherwise accessible in low-power mode. The cache may be implemented in a storage device and may be used to store and supply display data generated by the CPU or another high-speed processor. In one example, the cached display data can be retrieved in each frame refresh cycle while the display subsystem 904 is operated in low-speed mode. In some implementations, the cache is populated before entry into low-power mode. In some implementations, the DSP 916 can update the cache during low-power mode. In some implementations, the DSP 916 can merge display data received from the cache with data generated by the DSP 916 during low-power mode. For example, the DSP 916 may cause date or time information, battery charge level and/or other status information to be displayed during low-power mode.

The rate at which the display panel 930 is refreshed can be expected to change between high-speed and low-power modes. For example, certain mobile or portable devices have high-resolution displays with high bits-per-pixel depths and that are refreshed at between 30 and 120 frames per second (FPS) when operating in normal, high-speed modes. The use of the low-power serial bus 908 in low-power modes can limit the display refresh rate to 1 FPS or less in some implementations. Higher display refresh rates may be obtained using other protocols or serial bus configurations. In some implementations, partial frame refresh may be implemented in low power modes. Partial frame refresh may be used when the entire display is not subject to change during low power modes. For example, a mobile or portable device may change displayed date and time information by refreshing a predefined area of the display in which the date and time are displayed, thereby reducing the volume of data to transferred over the low-power serial bus 908.

In low-power mode, the low-power serial bus 908 can be used to manage the touch panel interface 932 in addition to transferring display data. In many instances, the highest FPS rate available through the low-power serial bus 908 is a prioritized objective and the touch panel interface 932 may experience increased bus latency which can affect responsiveness of the touch panel. Bus latency can affect the ability of a serial bus to handle high-priority, real-time and/or other time-constrained messages. In one example, bus latency may be measured as the time elapsed between a message becoming available for transmission and the delivery of the message or, in some instances, commencement of transmission of the message. Other measures of bus latency may be employed. Bus latency typically includes delays incurred while higher priority data or messages are transmitted, interrupt processing, the time required to terminate a datagram in process on the serial bus, the time to transmit commands causing bus turnaround between transmit mode and receive mode, bus arbitration and/or command transmissions specified by protocol. In conventional systems, a full touch interface is not supported in low-power modes. Detection of a touch event results in the DSP 916 notifying the CPU 912, or another processor or controller in the SoC 902, of the event and thereby initiate a switch to high-speed mode.

### Examples of Processing Circuits and Methods

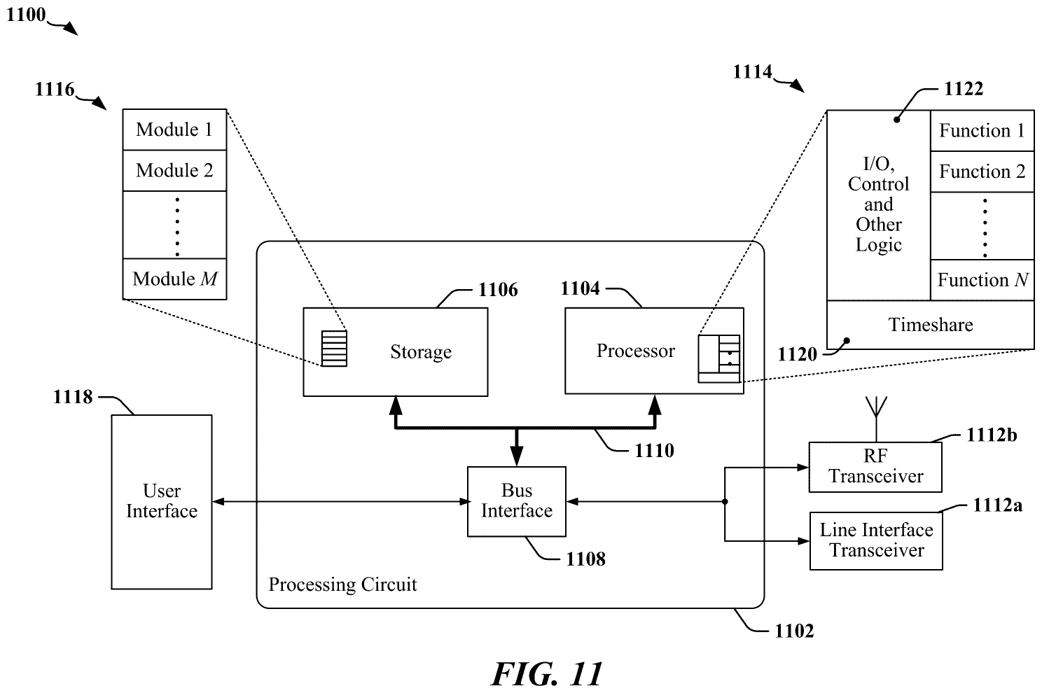

FIG. 11 is a diagram illustrating an example of a hardware implementation for an apparatus 1100. In some examples, the apparatus 1100 may perform one or more functions disclosed herein. In accordance with various aspects of the disclosure, an element, or any portion of an element, or any combination of elements as disclosed herein may be implemented using a processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112a, 1112b. A transceiver 1112a, 1112b may be provided for each networking technology supported by the processing circuit. In some instances, multiple networking technologies may share some or all of the circuitry or processing modules found in a transceiver 1112a, 1112b. Each transceiver 1112a, 1112b provides a means for communicating with various other apparatus over a transmission medium. In one example, a transceiver 1112a may be used to couple the apparatus 1100 to a multi-wire bus. In another example, a transceiver 1112b may be used to connect the apparatus 1100 to a radio access network. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement certain methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as a transceiver 1112a, 1112b, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to a transceiver 1112a, 1112b, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112a, 1112b, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

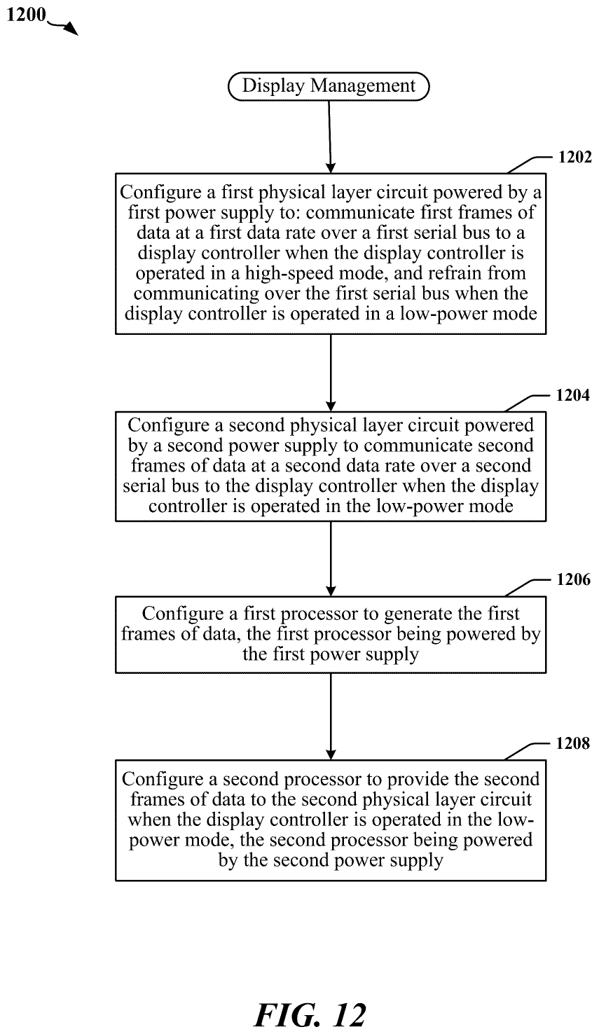

FIG. 12 is a flowchart 1200 of a method for operating a display subsystem configured in accordance with certain aspects of this disclosure. The method may be implemented in a mobile communication device that includes the display subsystem. In one example, a mobile communication device includes a first serial data link operated in accordance with DSI protocols and a second serial data link operated in accordance with SPI protocols. Other combinations of protocols may be used to operate the serial data links. The method may be performed using a combination of suitable processors such as controllers, finite state machines, digital signal processors, DPUs and/or CPUs.

At block 1202 in the illustrated method, a first physical layer circuit may be configured to communicate first frames of data at a first data rate over a first serial bus to a display controller when the display controller is operated in a high-speed mode. The first physical layer circuit may be further configured to refrain from communicating over the first serial bus when the display controller is operated in a low-power mode. The first physical layer circuit may be powered by a first power supply.

At block 1204, a second physical layer circuit may be configured to communicate second frames of data at a second data rate over a second serial bus to the display controller when the display controller is operated in the low-power mode. The second physical layer circuit may be powered by a second power supply. The second data rate may be lower than the first data rate. In some examples, the first data rate can support a frame refresh rate of between 30 and 120 FPS. In some examples, the second data rate can support a frame refresh rate of 1 FPS or less.

At block 1206, a first processor may be configured to generate the first frames of data. The first processor may be powered by the first power supply. In certain implementations, the first processor may be configured to generate frames of data when the display controller is operated in the high-speed mode and to refrain from generating frames of data when the display controller is operated in the low-power mode. The frames of data generated by the first processor may be stored in a cache or frame buffer. In one example, the first processor is a CPU in an SoC.

At block 1208, a second processor may be configured to provide the second frames of data to the second physical layer circuit when the display controller is operated in the low-power mode. The second processor may be powered by the second power supply. The cache or frame buffer may be accessed by a second processor, including when the display controller is operated in the low-power mode. The second processor may be configured to change or add to frames retrieved from the cache or frame buffer to obtain the second frames. In some implementations, the second processor can write frames to the cache or frame buffer.

In certain implementations, the first power supply provides power in the high-speed mode at a voltage that is greater than a voltage at which the second power supply provides power. The voltage at which the first power supply provides power may be reduced when the display controller is operated in the low-power mode. One or more devices or circuits powered by the first power supply may enter an idle, dormant, sleep or quiescent mode when the display controller is operated in the low-power mode. For example, the first processor may be configured to enter a dormant mode when the display controller is operated in the low-power mode. In another example, the first physical layer circuit may be configured to enter a dormant mode when the display controller is operated in the low-power mode. A low-power serial bus coupled to the first physical layer circuit may be idled when the physical layer circuit enters the dormant mode.

The first physical layer circuit may be configured to operate in accordance with a MIPI Alliance DSI protocol. In one example, the DSI protocol may comply or be compatible with C-PHY protocols. In another example, the DSI protocol may comply or be compatible with D-PHY protocols.

The second physical layer circuit may be configured to operate in accordance with a serial data communication protocol. In one example the physical layer circuit is configured to operate in accordance with SPI protocols. In another example the physical layer circuit is configured to operate in accordance with CCI protocols. In another example the physical layer circuit is configured to operate in accordance with I2C protocols. In another example the physical layer circuit is configured to operate in accordance with I3C protocols. In another example the physical layer circuit is configured to operate in accordance with SPMI protocols.

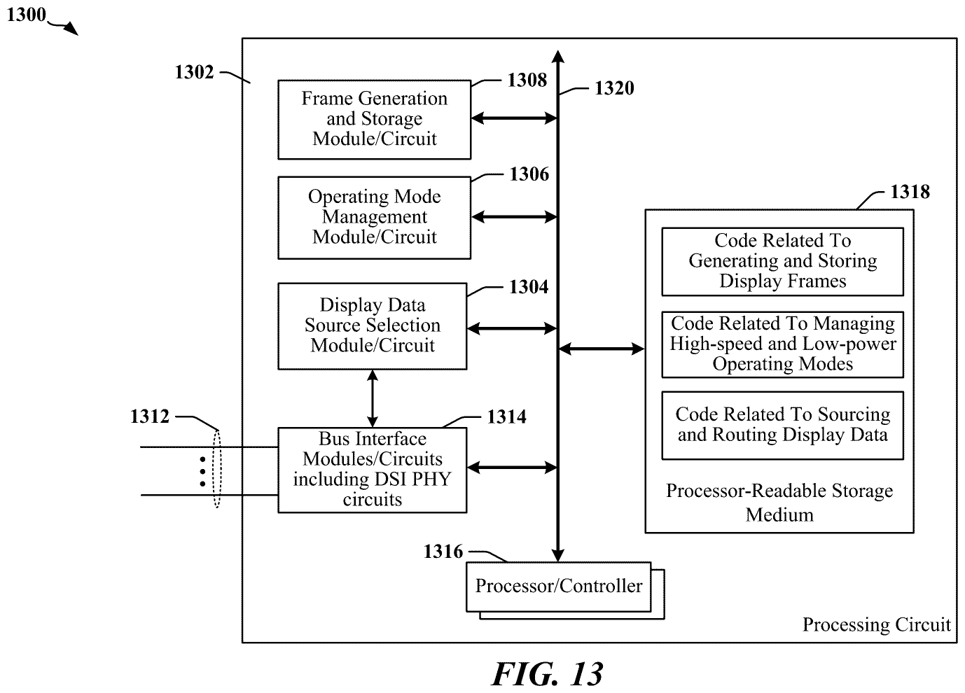

In some implementations, the second processor is configured to communicate with a touch panel interface associated with the display panel over the second physical layer circuit. The second processor may be configured to configure manage and control the operation of the touch panel interface. The second processor may be configured to communicate with the touch panel interface when the display controller is operated in the high-speed mode. The second processor may be configured to communicate with the touch panel interface when the display controller is operated in the low-power mode. FIG. 13 is a diagram illustrating a first example of a hardware implementation for an apparatus 1300 employing a processing circuit 1302. The processing circuit typically has one or more microprocessors, microcontrollers, digital signal processors, sequencers and/or state machines, represented generally by the processors 1316. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including multiple processors 1316, the modules or circuits 1304, 1306 and 1308 and the processor-readable storage medium 1318. A bus interface circuit and/or module 1314 may be provided to support communications over multiple serial data links 1312. The bus 1320 may also link various other circuits such as timing sources, peripherals, voltage regulators, and power management circuits, which are well known in the art, and therefore, will not be described any further.

The processors 1316 may be responsible for general processing, including the execution of software, code and/or instructions stored on the processor-readable storage medium 1318. The processor-readable storage medium 1318 may include a non-transitory storage medium. The software, when executed by the processors 1316, causes the processing circuit 1302 to perform the various functions described supra for any particular apparatus. The processor-readable storage medium may be used for storing data that is manipulated by the processors 1316 when executing software. The processing circuit 1302 further includes at least one of the modules 1304, 1306 and 1308. The modules 1304, 1306 and 1308 may be software modules running in the processors 1316, resident/stored in the processor-readable storage medium 1318, one or more hardware modules coupled to the processors 1316, or some combination thereof. The modules 1304, 1306 and 1308 may include microcontroller instructions, state machine configuration parameters, or some combination thereof.

In one configuration, the apparatus 1300 includes modules and/or circuits 1304 adapted to control operations of the bus interface circuit and/or module 1314 and to source and route display data over one the serial data links 1312 to a display driver. The apparatus 1300 may include modules and/or circuits 1306 adapted to monitor and respond to changes in operating modes, including operating modes that cause the display controller is operated in a high-speed mode and operating modes that cause the display controller is operated in a low-power mode. The apparatus 1300 may include modules and/or circuits 1308 adapted to generate, modify, configure store and retrieve display data. The display data may be stored in frame buffers or in cache memory.

The apparatus 1300 may include means for communicating with a display controller, including a first physical layer circuit powered by a first power supply and operable to communicate first frames of data at a first data rate over a first serial bus to the display controller when the display controller is operated in a high-speed mode, and refrain from communicating over the first serial bus when the display controller is operated in a low-power mode, and a second physical layer circuit powered by a second power supply and operable to communicate second frames of data at a second data rate over a second serial bus to the display controller when the display controller is operated in the low-power mode. The apparatus 1300 may include means for providing display data to the means for communicating with a display controller, including a first processor powered by the first power supply and configured to generate the first frames of data, and a second processor powered by the second power supply and configured to provide the second frames of data to the second physical layer circuit when the display controller is operated in the low-power mode.

In certain implementations, the first power supply provides power in the high-speed mode at a voltage that is greater than a voltage at which the second power supply provides power. The voltage at which the first power supply provides power may be reduced when the display controller is operated in the low-power mode. One or more devices or circuits powered by the first power supply may enter an idle, dormant, sleep or quiescent mode when the display controller is operated in the low-power mode. For example, the first processor may be configured to enter a dormant mode when the display controller is operated in the low-power mode. In another example, the first physical layer circuit may be configured to enter a dormant mode when the display controller is operated in the low-power mode. A low-power serial bus coupled to the first physical layer circuit may be idled when the physical layer circuit enters the dormant mode.

The first physical layer circuit may be configured to operate in accordance with a MIPI Alliance DSI protocol. In one example, the DSI protocol may comply or be compatible with C-PHY protocols. In another example, the DSI protocol may comply or be compatible with D-PHY protocols.

The second physical layer circuit may be configured to operate in accordance with a serial data communication protocol. In one example the physical layer circuit is configured to operate in accordance with SPI protocols. In another example the physical layer circuit is configured to operate in accordance with CCI protocols. In another example the physical layer circuit is configured to operate in accordance with I2C protocols. In another example the physical layer circuit is configured to operate in accordance with I3C protocols. In another example the physical layer circuit is configured to operate in accordance with SPMI protocols.

In some implementations, the second processor is configured to communicate with a touch panel interface associated with the display panel over the second physical layer circuit. The second processor may be configured to configure manage and control the operation of the touch panel interface. The second processor may be configured to communicate with the touch panel interface when the display controller is operated in the high-speed mode. The second processor may be configured to communicate with the touch panel interface when the display controller is operated in the low-power mode.

In one example, the apparatus 1300 is configured to operate as a mobile communication device that has a wireless transceiver configured to transmit and receive RF signals through one or more antennas, a bus interface circuit and/or module 1314 configured to couple the apparatus 1300 to a serial data link, and a controller or other processor. In this and other examples, the apparatus 1300 includes a display system interface. The display system interface has a physical layer circuit coupled to a serial bus and a controller. The display system interface is configurable to operate in accordance with MIPI Alliance DSI standards or specifications.

The apparatus 1300 may include a display controller coupled to a display panel. The apparatus 1300 may include a first physical layer circuit that is configured to communicate first frames of data at a first data rate over a first serial bus to a display controller when the display controller is operated in a high-speed mode. The first physical layer circuit may be further configured to refrain from communicating over the first serial bus when the display controller is operated in a low-power mode. The first physical layer circuit may be powered by a first power supply. The apparatus 1300 may include a second physical layer circuit that is configured to communicate second frames of data at a second data rate over a second serial bus to the display controller when the display controller is operated in the low-power mode. The second physical layer circuit may be powered by a second power supply. The second data rate may be lower than the first data rate. In some examples, the first data rate can support a frame refresh rate of between 30 and 120 FPS. In some examples, the second data rate can support a frame refresh rate of 1 FPS or less. The apparatus 1300 may include a first processor that is configured to generate the first frames of data. The first processor may be powered by the first power supply. In certain implementations, the first processor may be configured to generate frames of data when the display controller is operated in the high-speed mode and to refrain from generating frames of data when the display controller is operated in the low-power mode. The frames of data generated by the first processor may be stored in a cache or frame buffer. In one example, the first processor is a CPU in an SoC. The apparatus 1300 may include a second processor that is configured to provide the second frames of data to the second physical layer circuit when the display controller is operated in the low-power mode. The second processor may be powered by the second power supply. The cache or frame buffer may be accessed by a second processor, including when the display controller is operated in the low-power mode. The second processor may be configured to change or add to frames retrieved from the cache or frame buffer to obtain the second frames. In some implementations, the second processor can write frames to the cache or frame buffer. In certain implementations, the first power supply provides power in the high-speed mode at a voltage that is greater than a voltage at which the second power supply provides power. The voltage at which the first power supply provides power may be reduced when the display controller is operated in the low-power mode. One or more devices or circuits powered by the first power supply may enter an idle, dormant, sleep or quiescent mode when the display controller is operated in the low-power mode. For example, the first processor may be configured to enter a dormant mode when the display controller is operated in the low-power mode. In another example, the first physical layer circuit may be configured to enter a dormant mode when the display controller is operated in the low-power mode. A low-power serial bus coupled to the first physical layer circuit may be idled when the physical layer circuit enters the dormant mode.

The first physical layer circuit may be configured to operate in accordance with a MIPI Alliance DSI protocol. In one example, the DSI protocol may comply or be compatible with C-PHY protocols. In another example, the DSI protocol may comply or be compatible with D-PHY protocols.

The second physical layer circuit may be configured to operate in accordance with a serial data communication protocol. In one example the physical layer circuit is configured to operate in accordance with SPI protocols. In another example the physical layer circuit is configured to operate in accordance with CCI protocols. In another example the physical layer circuit is configured to operate in accordance with I2C protocols. In another example the physical layer circuit is configured to operate in accordance with I3C protocols. In another example the physical layer circuit is configured to operate in accordance with SPMI protocols.

In some implementations, the second processor is configured to communicate with a touch panel interface associated with the display panel over the second physical layer circuit. The second processor may be configured to configure manage and control the operation of the touch panel interface. The second processor may be configured to communicate with the touch panel interface when the display controller is operated in the high-speed mode. The second processor may be configured to communicate with the touch panel interface when the display controller is operated in the low-power mode.

The processor-readable storage medium 1318 may include instructions that cause the processing circuit 1302 to configure a first physical layer circuit to communicate first frames of data at a first data rate over a first serial bus to a display controller when the display controller is operated in a high-speed mode. The first physical layer circuit may be further configured to refrain from communicating over the first serial bus when the display controller is operated in a low-power mode. The first physical layer circuit may be powered by a first power supply.

The processor-readable storage medium 1318 may include instructions that cause the processing circuit 1302 to configure a second physical layer circuit to communicate second frames of data at a second data rate over a second serial bus to the display controller when the display controller is operated in the low-power mode. The second physical layer circuit may be powered by a second power supply. The second data rate may be lower than the first data rate. In some examples, the first data rate can support a frame refresh rate of between 30 and 120 FPS. In some examples, the second data rate can support a frame refresh rate of 1 FPS or less.

The processor-readable storage medium 1318 may include instructions that cause the processing circuit 1302 to generate the first frames of data. The first processor may be powered by the first power supply. In certain implementations, the first processor may be configured to generate frames of data when the display controller is operated in the high-speed mode and to refrain from generating frames of data when the display controller is operated in the low-power mode. The frames of data generated by the first processor may be stored in a cache or frame buffer. In one example, the first processor is a CPU in an SoC.

The processor-readable storage medium 1318 may include instructions that cause the processing circuit 1302 to configure a second processor to provide the second frames of data to the second physical layer circuit when the display controller is operated in the low-power mode. The second processor may be powered by the second power supply. The cache or frame buffer may be accessed by a second processor, including when the display controller is operated in the low-power mode. The second processor may be configured to change or add to frames retrieved from the cache or frame buffer to obtain the second frames. In some implementations, the second processor can write frames to the cache or frame buffer.

In certain implementations, the first power supply provides power in the high-speed mode at a voltage that is greater than a voltage at which the second power supply provides power. The voltage at which the first power supply provides power may be reduced when the display controller is operated in the low-power mode. One or more devices or circuits powered by the first power supply may enter an idle, dormant, sleep or quiescent mode when the display controller is operated in the low-power mode. For example, the first processor may be configured to enter a dormant mode when the display controller is operated in the low-power mode. In another example, the first physical layer circuit may be configured to enter a dormant mode when the display controller is operated in the low-power mode. A low-power serial bus coupled to the first physical layer circuit may be idled when the physical layer circuit enters the dormant mode.

The first physical layer circuit may be configured to operate in accordance with a MIPI Alliance DSI protocol. In one example, the DSI protocol may comply or be compatible with C-PHY protocols. In another example, the DSI protocol may comply or be compatible with D-PHY protocols.

The second physical layer circuit may be configured to operate in accordance with a serial data communication protocol. In one example the physical layer circuit is configured to operate in accordance with SPI protocols. In another example the physical layer circuit is configured to operate in accordance with CCI protocols. In another example the physical layer circuit is configured to operate in accordance with I2C protocols. In another example the physical layer circuit is configured to operate in accordance with I3C protocols. In another example the physical layer circuit is configured to operate in accordance with SPMI protocols.

In some implementations, the second processor is configured to communicate with a touch panel interface associated with the display panel over the second physical layer circuit. The second processor may be configured to configure manage and control the operation of the touch panel interface. The second processor may be configured to communicate with the touch panel interface when the display controller is operated in the high-speed mode. The second processor may be configured to communicate with the touch panel interface when the display controller is operated in the low-power mode. Some implementation examples are described in the following numbered clauses:
1. A mobile communication device, comprising: a display controller coupled to a display panel; a first physical layer circuit powered by a first power supply and configured to: communicate first frames of data at a first data rate over a first serial bus to the display controller when the display controller is operated in a high-speed mode, and refrain from communicating over the first serial bus when the display controller is operated in a low-power mode; a second physical layer circuit powered by a second power supply and configured to communicate second frames of data at a second data rate over a second serial bus to the display controller when the display controller is operated in the low-power mode; a first processor powered by the first power supply and configured to generate the first frames of data; and a second processor powered by the second power supply and configured to provide the second frames of data to the second physical layer circuit when the display controller is operated in the low-power mode.
2. The mobile communication device as described in clause 1, wherein the first power supply provides power in the high-speed mode at a voltage that is greater than a voltage at which the second power supply provides power.
3. The mobile communication device as described in clause 1 or clause 2, wherein a voltage at which the first power supply provides power is reduced when the display controller is operated in the low-power mode.
4. The mobile communication device as described in any of clauses 1-3, wherein the first processor is further configured to enter a dormant mode when the display controller is operated in the low-power mode.
5. The mobile communication device as described in any of clauses 1-4, wherein the first physical layer circuit is further configured to enter a dormant mode when the display controller is operated in the low-power mode.
6. The mobile communication device as described in any of clauses 1-5, wherein the first physical layer circuit is further configured to operate in accordance with Mobile Industry Processor Interface (MIPI) Alliance display serial interface (DSI) protocols.
7. The mobile communication device as described in any of clauses 1-6, wherein the second physical layer circuit is further configured to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.
8. The mobile communication device as described in any of clauses 1-7, wherein the second processor is further configured to communicate with a touch panel interface over the second physical layer circuit.
9. A method for operating a display in a mobile communication device, comprising: configuring a first physical layer circuit powered by a first power supply to: communicate first frames of data at a first data rate over a first serial bus to a display controller when the display controller is operated in a high-speed mode, and refrain from communicating over the first serial bus when the display controller is operated in a low-power mode; configuring a second physical layer circuit powered by a second power supply to communicate second frames of data at a second data rate over a second serial bus to the display controller when the display controller is operated in the low-power mode; configuring a first processor to generate the first frames of data, the first processor being powered by the first power supply; and configuring a second processor to provide the second frames of data to the second physical layer circuit when the display controller is operated in the low-power mode, the second processor being powered by the second power supply.
10. The method as described in clause 9, wherein the first power supply provides power in the high-speed mode at a voltage that is greater than a voltage at which the second power supply provides power.
11. The method as described in clause 9 or clause 10, wherein a voltage at which the first power supply provides power is reduced when the display controller is operated in the low-power mode.
12. The method as described in any of clauses 9-11, further comprising: configuring the first processor to enter a dormant mode when the display controller is operated in the low-power mode.
13. The method as described in any of clauses 9-12, further comprising: configuring the first physical layer circuit to enter a dormant mode when the display controller is operated in the low-power mode.
14. The method as described in any of clauses 9-13, further comprising: configuring the first physical layer circuit to operate in accordance with Mobile Industry Processor Interface (MIPI) Alliance display serial interface (DSI) protocols.
15. The method as described in any of clauses 9-14, further comprising: configuring the second physical layer circuit to operate in accordance with serial peripheral interface (SPI) protocol, a Camera Control Interface (CCI) protocol, an Inter-Integrated Circuit (I2C) protocol, an Improved Inter-Integrated Circuit (I3C) protocol or a system power management interface (SPMI) protocol.
16. The method as described in any of clauses 9-15, further comprising: configuring the second processor to communicate with a touch panel interface over the second physical layer circuit.
17. An apparatus comprising: means for communicating with a display controller including: a first physical layer circuit powered by a first power supply and operable to communicate first frames of data at a first data rate over a first serial bus to the display controller when the display controller is operated in a high-speed mode, and refrain from communicating over the first serial bus when the display controller is operated in a low-power mode; and a second physical layer circuit powered by a second power supply and operable to communicate second frames of data at a second data rate over a second serial bus to the display controller when the display controller is operated in the low-power mode; means for providing display data to the means for communicating with the display controller, including: a first processor powered by the first power supply and configured to generate the first frames of data; and a second processor powered by the second power supply and configured to provide the second frames of data to the second physical layer circuit when the display controller is operated in the low-power mode.
18. The apparatus as described in clause 17, wherein the first power supply provides power in the high-speed mode at a voltage that is greater than a voltage at which the second power supply provides power, and wherein a voltage at which the first power supply provides power is reduced when the display controller is operated in the low-power mode.
19. The apparatus as described in clause 17 or clause 18, wherein the first processor is configured to enter a dormant mode when the display controller is operated in the low-power mode.
20. The apparatus as described in any of clauses 17-19, wherein the first physical layer circuit is configured to enter a dormant mode when the display controller is operated in the low-power mode.
21. The apparatus as described in any of clauses 17-20, wherein the first physical layer circuit is configured to operate in accordance with Mobile Industry Processor Interface (MIPI) Alliance display serial interface (DSI) protocols.
22. The apparatus as described in any of clauses 17-21, wherein the second physical layer circuit is configured to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.
23. The apparatus as described in any of clauses 17-22, wherein the second processor is configured to communicate with a touch panel interface over the second physical layer circuit.
24. A processor-readable storage medium comprising code for: configuring a first physical layer circuit powered by a first power supply to: communicate first frames of data at a first data rate over a first serial bus to a display controller when the display controller is operated in a high-speed mode, and refrain from communicating over the first serial bus when the display controller is operated in a low-power mode; configuring a second physical layer circuit powered by a second power supply to communicate second frames of data at a second data rate over a second serial bus to the display controller when the display controller is operated in the low-power mode; configuring a first processor to generate the first frames of data, the first processor being powered by the first power supply; and configuring a second processor to provide the second frames of data to the second physical layer circuit when the display controller is operated in the low-power mode, the second processor being powered by the second power supply.
25. The storage medium as described in clause 24, wherein a first power supply provides power in the high-speed mode at a voltage that is greater than a voltage at which the second power supply provides power, and wherein a voltage at which the first power supply provides power is reduced when the display controller is operated in the low-power mode.
26. The storage medium as described in clause 24 or clause 25, further comprising: configuring the first processor to enter a dormant mode when the display controller is operated in the low-power mode.
27. The storage medium as described in any of clauses 24-26, further comprising: configuring the first physical layer circuit to enter a dormant mode when the display controller is operated in the low-power mode.
28. The storage medium as described in any of clauses 24-27, further comprising: configuring the first physical layer circuit to operate in accordance with Mobile Industry Processor Interface (MIPI) Alliance display serial interface (DSI) protocols.
29. The storage medium as described in any of clauses 24-28, further comprising: configuring the second physical layer circuit to operate in accordance with serial peripheral interface (SPI) protocol, a Camera Control Interface (CCI) protocol, an Inter-Integrated Circuit (I2C) protocol, an Improved Inter-Integrated Circuit (I3C) protocol or a system power management interface (SPMI) protocol.
30. The storage medium as described in any of clauses 24-29, further comprising: configuring the second processor to communicate with a touch panel interface over the second physical layer circuit.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A mobile communication device, comprising:
a display controller coupled to a display panel;
a first physical layer circuit powered by a first power supply and configured to:
communicate first frames of data at a first data rate over a first serial bus to the display controller when the display controller is operated in a high-speed mode, and
refrain from communicating over the first serial bus when the display controller is operated in a low-power mode;
a second physical layer circuit powered by a second power supply and configured to communicate second frames of data at a second data rate over a second serial bus to the display controller when the display controller is operated in the low-power mode;
a first processor powered by the first power supply and configured to generate the first frames of data; and
a second processor powered by the second power supply and configured to provide the second frames of data to the second physical layer circuit when the display controller is operated in the low-power mode.

2. The mobile communication device of claim 1, wherein the first power supply provides power in the high-speed mode at a voltage that is greater than a voltage at which the second power supply provides power.

3. The mobile communication device of claim 1, wherein a voltage at which the first power supply provides power is reduced when the display controller is operated in the low-power mode.

4. The mobile communication device of claim 1, wherein the first processor is further configured to enter a dormant mode when the display controller is operated in the low-power mode.

5. The mobile communication device of claim 1, wherein the first physical layer circuit is further configured to enter a dormant mode when the display controller is operated in the low-power mode.

6. The mobile communication device of claim 1, wherein the first physical layer circuit is further configured to operate in accordance with Mobile Industry Processor Interface (MIPI) Alliance display serial interface (DSI) protocols.

7. The mobile communication device of claim 1, wherein the second physical layer circuit is further configured to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.

8. The mobile communication device of claim 1, wherein the second processor is further configured to communicate with a touch panel interface over the second physical layer circuit.

9. A method for operating a display in a mobile communication device, comprising:
configuring a first physical layer circuit powered by a first power supply to:
communicate first frames of data at a first data rate over a first serial bus to a display controller when the display controller is operated in a high-speed mode, and
refrain from communicating over the first serial bus when the display controller is operated in a low-power mode;
configuring a second physical layer circuit powered by a second power supply to communicate second frames of data at a second data rate over a second serial bus to the display controller when the display controller is operated in the low-power mode;
configuring a first processor to generate the first frames of data, the first processor being powered by the first power supply; and
configuring a second processor to provide the second frames of data to the second physical layer circuit when the display controller is operated in the low-power mode, the second processor being powered by the second power supply.

10. The method of claim 9, wherein the first power supply provides power in the high-speed mode at a voltage that is greater than a voltage at which the second power supply provides power.

11. The method of claim 9, wherein a voltage at which the first power supply provides power is reduced when the display controller is operated in the low-power mode.

12. The method of claim 9, further comprising:
configuring the first processor to enter a dormant mode when the display controller is operated in the low-power mode.

13. The method of claim 9, further comprising:
configuring the first physical layer circuit to enter a dormant mode when the display controller is operated in the low-power mode.

14. The method of claim 9, further comprising:
configuring the first physical layer circuit to operate in accordance with Mobile Industry Processor Interface (MIPI) Alliance display serial interface (DSI) protocols.

15. The method of claim 9, further comprising:
configuring the second physical layer circuit to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.

16. The method of claim 9, further comprising:
configuring the second processor to communicate with a touch panel interface over the second physical layer circuit.

17. An apparatus, comprising:
means for communicating with a display controller including:
a first physical layer circuit powered by a first power supply and operable to communicate first frames of data at a first data rate over a first serial bus to the display controller when the display controller is operated in a high-speed mode, and refrain from communicating over the first serial bus when the display controller is operated in a low-power mode; and
a second physical layer circuit powered by a second power supply and operable to communicate second frames of data at a second data rate over a second serial bus to the display controller when the display controller is operated in the low-power mode;
means for providing display data to the means for communicating with the display controller, including:
a first processor powered by the first power supply and configured to generate the first frames of data; and
a second processor powered by the second power supply and configured to provide the second frames of data to the second physical layer circuit when the display controller is operated in the low-power mode.

18. The apparatus of claim 17, wherein the first power supply provides power in the high-speed mode at a voltage that is greater than a voltage at which the second power supply provides power, and wherein a voltage at which the first power supply provides power is reduced when the display controller is operated in the low-power mode.

19. The apparatus of claim 17, wherein the first processor is configured to enter a dormant mode when the display controller is operated in the low-power mode.

20. The apparatus of claim 17, wherein the first physical layer circuit is configured to enter a dormant mode when the display controller is operated in the low-power mode.

21. The apparatus of claim 17, wherein the first physical layer circuit is configured to operate in accordance with Mobile Industry Processor Interface (MIPI) Alliance display serial interface (DSI) protocols.

22. The apparatus of claim 17, wherein the second physical layer circuit is configured to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.

23. The apparatus of claim 17, wherein the second processor is configured to communicate with a touch panel interface over the second physical layer circuit.

24. A processor-readable storage medium comprising code for:
configuring a first physical layer circuit powered by a first power supply to:
communicate first frames of data at a first data rate over a first serial bus to a display controller when the display controller is operated in a high-speed mode, and
refrain from communicating over the first serial bus when the display controller is operated in a low-power mode;
configuring a second physical layer circuit powered by a second power supply to communicate second frames of data at a second data rate over a second serial bus to the display controller when the display controller is operated in the low-power mode;
configuring a first processor to generate the first frames of data, the first processor being powered by the first power supply; and
configuring a second processor to provide the second frames of data to the second physical layer circuit when the display controller is operated in the low-power mode, the second processor being powered by the second power supply.

25. The storage medium of claim 24, wherein a first power supply provides power in the high-speed mode at a voltage that is greater than a voltage at which the second power supply provides power, and wherein a voltage at which the first power supply provides power is reduced when the display controller is operated in the low-power mode.

26. The storage medium of claim 24, further comprising:
configuring the first processor to enter a dormant mode when the display controller is operated in the low-power mode.

27. The storage medium of claim 24, further comprising:
configuring the first physical layer circuit to enter a dormant mode when the display controller is operated in the low-power mode.

28. The storage medium of claim 24, further comprising:
configuring the first physical layer circuit to operate in accordance with Mobile Industry Processor Interface (MIPI) Alliance display serial interface (DSI) protocols.

29. The storage medium of claim 24, further comprising:
configuring the second physical layer circuit to operate in accordance with serial peripheral interface (SPI) protocol, a Camera Control Interface (CCI) protocol, an Inter-Integrated Circuit (I2C) protocol, an Improved Inter-Integrated Circuit (13C) protocol or a system power management interface (SPMI) protocol.

30. The storage medium of claim 24, further comprising:
configuring the second processor to communicate with a touch panel interface over the second physical layer circuit.
